(19) United States
(12) Patent Application Publication
(10) Pub. No.: US 2015/0324877 A1
(43) Pub. Date: Nov. 12, 2015

(54) ECOMMERCE SYSTEM FOR MARKETING MIXED-LOTS OF DISTRESSED INVENTORY

(71) Applicant: Underground Cellar, San Francisco, CA (US)

(72) Inventors: Jeffrey Barrett Shaw, San Francisco, CA (US); Andrey Yruski, San Francisco, CA (US)

(21) Appl. No.: 14/705,601

(22) Filed: May 6, 2015

Related U.S. Application Data
(60) Provisional application No. 61/989,235, filed on May 6, 2014.

(51) Int. Cl. G06Q 30/06; G06Q 30/02

(52) U.S. Cl. CPC G06Q 30/0605; G06Q 30/0222; G06Q 30/0635

(57) ABSTRACT

An ecommerce system for marketing mixed lots of distressed inventory, as embodied in various systems, methods, and non-transitory computer-readable storage media, is provided. The system may generate and communicate offers for mixed lots of distressed inventory. Individual buyers may join together to form buying teams that may collectively purchase a mixed lot. The system may charge buyers and distribute portions of the purchased lot, some of which may be upgraded items, to individual buyers based on respective levels of demand indicated by each buyer. The system may also include a network-based inventory tracking function that permits buyers to store electronic representations or records of purchased items in a remote storage location. The system may then aggregate the purchased items for shipping at a later time.

### CROSS-REFERENCE TO RELATED APPLICATION

This application claims the priority benefit of U.S. provisional application No. 61/989,235 filed May 6, 2014 and titled “Method and System for marketing Mixed-Lots of Distressed Inventory,” the disclosure of which is hereby incorporated by reference.

### BACKGROUND

1. Technical Field

The present disclosure concerns electronic commerce (“ecommerce”) systems. More particularly, the present disclosure concerns an ecommerce system for marketing mixed lots of distressed inventory.

2. Background Art

In a conventional brick-and-mortar retail scenario, a customer chooses the exact item they wish to purchase and, after paying the listed sales price, may leave the store with the merchandise. Closed-container (e.g., storage locker) auctions are another type of conventional transaction scenario. In a closed-container auction scenario, a buyer guided by only limited information included with a purchase offer purchases an entire container based on its anticipated contents. The limited information available to the buyer typically includes the size, weight, and dimensions of the container and anything else the seller wishes to provide. Sometimes, as is the case with storage lockers, the buyer can partially look at the lot of items prior to purchasing, but is not allowed to inspect any specific item or open any boxes. Because the contents of the lot are ultimately and because the buyer has no way of ensuring that the purchase is a good deal, prospective buyers face a big risk when dealing with container-based transactions.

By providing a convenient mechanism for marketing products, the Internet has given rise to many websites that offer products for sale (i.e., ecommerce websites). Generally, a potential customer viewing such an ecommerce website indicates a desire to buy a particular product by clicking on a particular location on the display screen. Some ecommerce websites require a user to register by giving a name, address, and credit card information. Later, when a customer desires to buy a product, the information entered during registration is used for billing and shipping purposes.

Some ecommerce websites allow a buyer to bid on products that are offered in the Internet equivalent of an auction. Other ecommerce websites allow a user to make an offer to buy products at a price specified by the buyer (e.g., akin to an individual making an offer to buy a product at a particular price in a face-to-face situation). Some ecommerce websites allow a buyer to purchase new items, while others offer the same items but in used or salvaged condition. Products may be sold individually or grouped together into “lots” of the same or mixed groups of merchandise.

Although existing ecommerce websites provide more flexible and rapid purchasing options for consumers, they are limited in their manage and offer mixed lots of distressed inventory.

### SUMMARY OF THE CLAIMED INVENTION

An ecommerce system for marketing mixed lots of distressed inventory, as embodied in various systems, methods, and non-transitory computer-readable storage media, is provided.

In a claimed embodiment, a method for facilitating a buyer to participate in purchasing a portion of an aggregated mixed lot of goods from a seller includes receiving, by way of a communication network, offer information from a seller. The offer information is received at a server and includes an itemized manifest of items within the aggregated mixed lot of goods. The offer information also includes an indication that the aggregated mixed lot of goods includes one or more upgraded items. The offer information also includes a price for an item. The method may include executing instructions stored in memory. By way of executing the instructions, the method includes storing the offer information received from the seller in a non-transitory computer readable storage medium. The method further includes receiving an offer corresponding to the offer information and delivering a request from the buyer to the seller to purchase the portion of the aggregated mixed lot of goods. The method includes delivering a payment from the buyer corresponding to the purchase. The method further includes receiving a detailed item list of all goods the buyer purchased.

In another claimed embodiment, a method for storing an inventory of purchased items and aggregating one or more of the purchased items in the inventory for shipment includes maintaining an inventory of the purchased items. The inventory is maintained at a server. The one or more of the purchased items were purchased at different times. The method includes transmitting a request over a communication network from a computing device to ship at least one of the purchased items to a predetermined location. The method also includes, by way of executing instructions stored in memory, aggregating the requested items to be shipped, offering a discounted shipping rate for shipping the aggregated items, and finalizing the shipping instructions.

In a further claimed embodiment, an apparatus for storing an inventory of purchased items and aggregating one or more purchased items in the inventory for shipment includes a processor, a network interface communicatively coupled to a communications network, and memory. The memory stores the inventory of the purchased items, one or more of which were purchased at different times. The network interface, by way of the communications network, transmits a request from a computing device to ship at least one of the purchased items to a predetermined location. By way of executing instructions stored in memory, the processor aggregates the requested items to be shipped, offers a discounted shipping rate for shipping the aggregated items, and finalizes the shipping instructions.

In yet a further claimed embodiment, a non-transitory computer-readable storage medium may include a computer program that, when executed by a processor, performs a method for storing an inventory of purchased items and aggregating one or more of the purchased items in the inventory for shipment as described above.

### BRIEF DESCRIPTION OF THE DRAWINGS

FIG. 1 illustrates an exemplary network environment in which the ecommerce system may be implemented.

FIG. 2 illustrates an exemplary graphical user interface that may be rendered and displayed at buyer client device.

FIG. 3 illustrates an operational flow of an exemplary ecommerce system for marketing mixed lots of distressed inventory.

FIG. 4 illustrates an exemplary operational process performed by the system when receiving and communicating an offer for sale.

FIG. 5 illustrates an exemplary operational process performed by the system when presenting an offer for sale to one or more prospective buyers.

FIG. 6 illustrates an exemplary operational process performed by the system when a potential buyer joins a buying team.

FIG. 7 illustrates an exemplary operational process performed by the system when accepting an offer.

FIG. 8 illustrates an exemplary operational process performed by the system when canceling an offer.

FIG. 9 illustrates an exemplary network environment in which another embodiment of an ecommerce system may be implemented.

### DETAILED DESCRIPTION

An ecommerce solution for marketing mixed lots of distressed inventory, as embodied in various systems, methods, and non-transitory computer-readable storage media, is provided.

The following terms may be referenced throughout the present disclosure. The definitions provided are merely exemplary and should not be construed as the sole manner through which the terms may be defined or understood. For purposes of the present disclosure, the term “product” may refer to either a product or service. The term “lot” or “lot of goods” may refer to the contents of an offer. The term “portion” or the phrase “portion of a lot” may refer to an individual segment of a lot that may be allocated to a buyer. The phrase “flexible terms” may refer to attributes of an offer that require flexibility on the part of the buyer (e.g., varying terms and conditions). The phrase “aggregated demand” may refer to the collective demand expressed by a plurality of potential buyers for a given offer (e.g., as might be measured by the total amount of products that the buyers have indicated a desire to purchase). The phrase “buying team” may mean a group of buyers who have all expressed a desire to participate in a particular offer.

The term “all-or-nothing requirement” may refer to a requirement by which the seller requires the system to cancel the offer unless all portions of the lot are claimed by buyers. The term “buying cycle” may refer to a period in which buyers may indicate a desire to purchase a product. The terms “maximum available amount” or “total maximum units” may refer to the maximum quantity of portions of a lot that a seller is willing to offer during a buying cycle. The term “system operator” may refer to an individual or entity that operates or is otherwise responsible for the one or more computing systems or web servers that carry out the ecommerce system functionality described herein. The term “distressed inventory” may refer to returned inventory, overstocked items, expiring goods, salvaged products, other difficult-to-sell items, or any other item that a seller wishes to move quickly. The term “distressed inventory liquidation” may refer to the act of quickly selling distressed inventory (e.g., to make room for new incoming inventory). The term “manifest” may refer to a list of all items in a particular lot, along with any specifications, terms, or other information provided by the seller.

The novel ecommerce solution described herein introduces an entirely new paradigm of online shopping. The solution may include aggregating buyers willing to accept flexible terms specified by sellers. Rather than purchasing a specific item from a seller, buyers stake a claim to one or more items from a mixed lot of a plurality of items. The solution may include communicating seller-configured offers by way of one or more graphical user interfaces accessible by, for instance, a local network browser application executed on a client device associated with a given buyer. The presented offers may each include an identification of a plurality of different items of merchandise or “portions” in a mixed lot. The solution may include guaranteeing to a prospective buyer that the buyer will receive at least one of the items in the lot if the offer is accepted. In addition to the offer itself, additional information may be transmitted to the potential buyer (e.g., the condition of the items in the lot and any relevant offer deadlines or expiration dates).

The solution gives sellers and buyers enhanced flexibility over prior ecommerce solutions. Sellers may maximize profits and limit losses from reprocessing and redistribution costs associated with “distressed inventory” such as customer returns, overstocks, expiring goods, and other difficult to sell items. Buyers may enjoy the opportunity to access individual portions of distressed inventory that might otherwise only be offered as an entire lot that the buyer could not afford on his or her own.

In one exemplary scenario, a seller who owns an electronics retail store in Arizona may possess 100 televisions returned by customers in a given month. The televisions may range in screen size from 26″ to 65″ and may include a plurality of different makes and models. The seller may have a new shipment of televisions coming in and may need to quickly liquidate the 100 customer-returned televisions to make room for the newer, more-profitable televisions. The returned televisions may range in value from $350 to $2,500 (manufacturer's suggested retail price or “MSRP”) with an average MSRP of about $500 per television. Afforded the benefits offered by the ecommerce solution described herein (e.g., as embodied by an ecommerce system), the seller may list all of the returned televisions in a single lot and may charge 100 individual buyers a set price to be guaranteed one of the televisions. The seller may, for instance, offer each portion of the lot (i.e., a single television) for $350—the value of the least expensive television in the lot. So long as the offer is ultimately accepted, which may include sufficient buyers expressing demand in the offer to meet a predetermined threshold demand level, all of the buyers may be guaranteed to receive a television whose MSRP is at least what they paid. Because the lot includes televisions spanning a wide spectrum of sizes and values, some of the buyers will receive televisions worth far greater than what they paid. Thus, any individual buyer may enjoy the potential but not guaranteed prospect of obtaining a great deal. At worst, in the example provided, an individual buyer may merely receive a television worth exactly what the buyer paid.

As for the seller, the seller may receive $35,000 in revenue and the benefit of having quickly moved distressed inventory. Although the $35,000 figure represents a 30% undercut to MSRP in this example, sellers are typically willing to liquidate distressed inventory for as much as 60-80% off to wholesalers who purchase salvaged lots in bulk by the pallet or truckload through traditional merchandise liquidation channels. Thus, the mere 30% reduction in revenue represents a significant improvement.

In another exemplary scenario, a wine distributor may possess 1200 bottles of last season's wine that the distributor needs to quickly sell to make room for a new shipment arriving. Using the ecommerce solution described herein, the distributor may configure and present an offer to liquidate the 1200 distressed bottles. The distributor may, for instance, supply offer information to an exemplary ecommerce system that permits the system to generate a manifest of items for sale. In the present example, the manifest may appear in the form of the following table or list:

MANIFEST

| | | | |
|---|---|---|---|
| QTY: 1 × | Brandname1 | Wine Title1 | MSRP: $1100 per bottle |
| QTY: 9 × | Brandname2 | Wine Title2 | MSRP: $100 per bottle |
| QTY: 40 × | Brandname3 | Wine Title3 | MSRP: $50 per bottle |
| QTY: 50 × | Brandname4 | Wine Title4 | MSRP: $20 per bottle |
| QTY: 100 × | Brandname5 | Wine Title5 | MSRP: $10 per bottle |
| QTY: 150 × | Brandname6 | Wine Title6 | MSRP: $10 per bottle |
| QTY: 150 × | Brandname7 | Wine Title7 | MSRP: $10 per bottle |
| QTY: 150 × | Brandname8 | Wine Title8 | MSRP: $10 per bottle |
| QTY: 150 × | Brandname9 | Wine Title9 | MSRP: $10 per bottle |
| QTY: 150 × | Brandname10 | Wine Title10 | MSRP: $10 per bottle |
| QTY: 250 × | Brandname11 | Wine Title11 | MSRP: $10 per bottle |

Terms: This lot contains 1200 bottles of wine ranging in MSRP from $10
to $1100 per bottle. There are 100 portions of this lot available. Each buy-
er will receive 12 bottles (1 case) per portion. Bottles received may be all
the same or may be a mixture of the wines listed.
Price: $120 per portion ($10 per bottle).

In the exemplary wine offer above, all buyers may pay $10 per bottle. Although every bottle a buyer receives will be worth at least $10, some bottles will be worth $20, $50, $100 and even up to $1100. Thus, each buyer enjoys the prospect of obtaining a high quality bottle of wine for only $10, while at the same time enjoying a guarantee that each bottle received will be worth at least the purchase price of $10. Regardless of which bottles are received, each buyer who joins in on the deal (i.e., joins other prospective buyers who have expressed interest in the lot so as to form a “buying team”) pays the same flat price of $120 for 12 bottles. Had the seller been able to sell the bottles at full retail, the seller would have generated $16,000 in revenue. If the seller had used traditional wine liquidation channels, the seller would have had to undercut MSRP by as much as 80%. Employing the ecommerce system described herein, on the other hand, would permit the seller in the present example to generate $12,000, which represents a mere 25% undercut to MSRP.

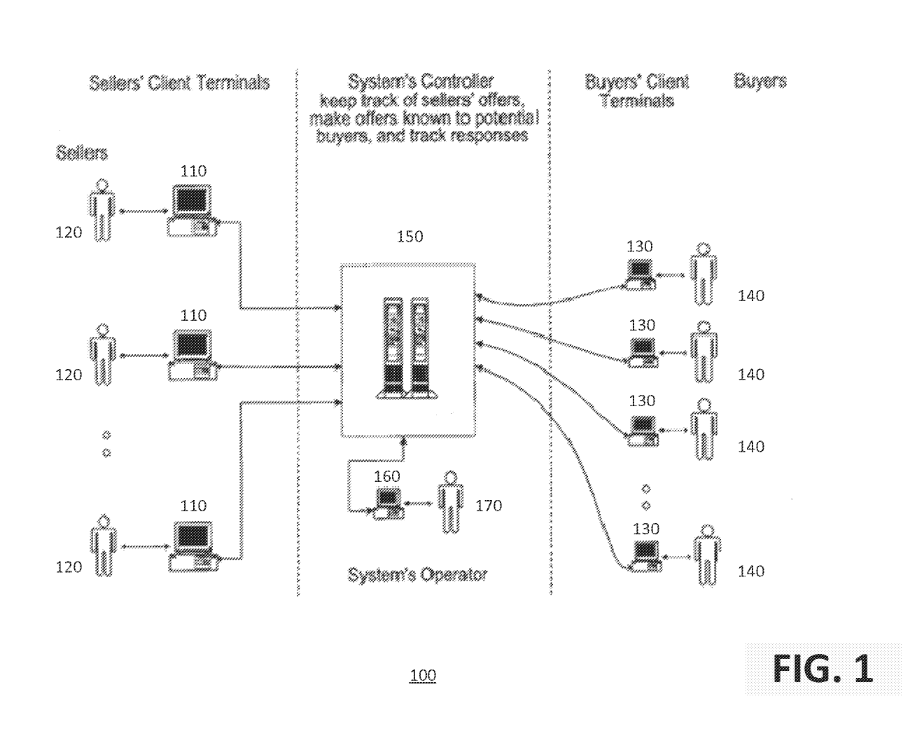

FIG. 1 illustrates an exemplary network environment 100 in which an ecommerce system may be implemented. Environment 100 may include one or more seller client devices 110, each of which may be associated with a seller 120. Environment 100 may include one or more buyer client devices 130, each of which may be associated with a buyer 140. FIG. 1 depicts an arbitrary number of sellers 120 and buyers 140 for illustrative purposes only. Persons of ordinary skill in the art will readily appreciate that the environment 100 may include at little as one seller 120 and one buyer 140, or it may include numerous sellers 120 and buyers 140.

Environment 100 may further include a computing system 150 communicatively coupled between seller client devices 110 and buyer client devices 130 by a communications network. Computing system 150 may be or function as a system controller. System controller 150 may be communicatively coupled to an operator client device 160, which may be associated with a system operator 170. System controller 150 may be a single server or multiple servers communicatively coupled to one another. In some embodiments, system controller 150 may be a computing system that includes multiple computing devices (e.g., network servers, application servers, database servers, routers, gateways, switches, etc.) communicatively coupled to one another by a communications network. In one embodiment, for instance, system controller 150 may include one or more application servers and/or network servers executing software that performs one or more predetermined functionalities. The software may, upon being executed, keep track of seller offers, including optional flexible terms conditions. The software may further intelligently control the appearance of the offers on one or more physical or virtual media (e.g., a website). The software may also appropriately track and/or process purchase requests by buyers who may see and respond to such offers.

Persons of ordinary skill in the art will readily recognize and appreciate that, in view of FIG. 1, the communications network may be implemented as a private network, a public network, an intranet, the Internet, or any suitable combination of the foregoing. By virtue of being communicatively coupled to one another by the communications network, seller client devices 110, system controller 150, and buyer client devices 140 may communicate with one another.

Client devices 110, 130, and 160 may each be a computing device, such as a desktop computer, workstation, laptop, smartphone, tablet, WebTV, interactive or two-way TV, PDA, information appliance, or any other device that can be used by seller 120, buyer 140, or operator 170 to communicate with system controller 150 over a network. Client devices 110, 130, and 160 may each be communicatively coupled to the network at a network interface and may each be coupled either directly to network or through any number of intermediate network servers, gateways, or other suitable computing devices. Client devices 110, 130, and 160 may each include a network browser application through which a user may access network-based applications. The network browser may be a locally stored client application such as Chrome™, FireFox™, Safari™, Opera™, Internet Explorer™, or the like.

In the exemplary environment 100 depicted in FIG. 1, the system displays offers by way of a graphical user interface (e.g., a website) managed by system operator 170. The graphical user interface is hosted by system controller 150, which may include one or more web servers. If a particular company wishes to offer aggregated demand distressed inventory liquidation on its own company website, the company may implement a system like the one illustrated in FIG. 1. In some embodiments, more than one website may be hosted on a single server of system controller 150. Persons of ordinary skill in the art will appreciate that the system and environment illustrated in FIG. 1 is merely exemplary and that many possible architecture configurations are possible.

In other embodiments, the system may include one or more media generators that display offers. The one or more media generators may include interactive presentation devices, such as hand-held devices, interactive televisions, mobile phones, and the like. As discussed above, in one embodiment the system may allow one or more sellers to present one or more team buy offers to one or more potential buyers through one or more web sites. In an alternative embodiment, a system may offer a single offer of a mixed lot of distressed inventory to multiple buyers. In some embodiments, the graphical user interface through which the system may do so may include the seller's own website. An online retail company, for instance, may use such an embodiment to offer a lot of distressed inventory to aggregated buyers on the company's own websites. The system may, for example, offer a truckload of various wine bottles on behalf of the company. The system may display the offer with a description that reads: “Last season's wine at $10 a bottle; some bottles valued at over $200!” The system may automatically accept indications of interest (i.e., aggregate demand) from one or more people who are interested in joining the buying team for the wine offer.

In still other embodiments, the system may offer the portions of the lot as “closed-container” offers. In such cases, the system may not provide a manifest of items to the user. Instead, the system may offer only limited information about what items the buyer might receive if the offer is accepted. In some embodiments, the system may offer no information at all regarding the items included in the closed-contained lot.

In one embodiment, a method for facilitating a buyer to participate in purchasing a portion of an aggregated mixed lot of goods from seller 120 may include receiving, by way of the communication network, offer information from seller 120. The offer information may be received by system controller 150, which may include one or more servers. The offer information received by system controller 150 may include an itemized manifest of items included within the aggregated mixed lot of goods. The offer information may further include an identification of one or more upgraded items within the aggregated mixed lot of goods. The identification may, in some embodiments, be an identification of the percentage or quantity of items in the mixed lot that are upgraded (e.g., items that are worth more than other items included in the mixed lot). The information about the upgraded items may also include a name, an image, an identification of the item manufacturer, the MSRP, the percentage of the upgraded items included in the mixed lot, and other information. In some embodiments, the method may include intentionally omitting any information about the upgraded items aside from the fact that the lot includes one or more upgraded items. The offer information may further include a price for an item within the mixed lot of goods. In some embodiments, the offer information may further include delivery information.

The method may further include executing instructions stored in memory of system controller 150. By way of executing the instructions with a processor of system controller 150, the method may include storing the offer information received from seller 120 (by way of seller client device 110) in a non-transitory computer readable storage medium (e.g., a hard disk). The method may further include receiving an offer corresponding to the offer information. System controller 150 may receive the offer from one or more of buyers 140 by way of one or more buyer client device 130. The method may include delivering a request from buyer 140 to seller 120 to purchase the portion of the aggregated mixed lot of goods (i.e., the advertised item). The method may also include delivering a payment from buyer 140 to seller 120. The payment may correspond to the purchase of the lot portion. The method may include receiving a detailed item list of all goods purchased by buyer 140. The detailed item list of all goods may include details of any upgraded items included in the purchase (e.g., an identification of the specific upgraded items included in the purchase, a general indication that upgraded items are included in the purchase, or the like). In other embodiments, the detailed item list of all goods may intentionally omit any information about any upgraded items included in the purchase. In such embodiments, the method may provide an element of thrill and surprise as buyers must wait until delivery to discover whether or not the portions they purchased contained any upgraded items.

By way of example, in one scenario an offer may include 10 different types of wine bottles that vary in value from $10 to $150. A prospective buyer need only pay the specified price to join the buying team, which could be as low as $10 per portion (e.g., per bottle). In that case, a prospective buyer can purchase 12 bottles for only $120. In one embodiment, the system may inform the buyer that 50% of the 12 purchased bottles are upgraded. The system may omit information that might suggest exactly which bottles are worth more than the basic price of $10 per bottle. When the buyer completes the purchase and pays, the system may then provide a detailed identification of the purchased bottles. The buyer may, at that point, be met with the pleasant surprise of learning that one of the upgraded bottles was a $150 bottle. Thus, the ecommerce system permits sellers to conveniently offer and liquidate distressed inventory (e.g., inventory returned by customers, overstocked items, expiring goods, salvaged products, and other difficult-to-sell items).

Afforded the benefits of the present system, a seller may offer steep discounts to buyers willing to accept flexible terms. The present system overcomes a persistent problem in the field of electronic distressed inventory liquidation. Namely, although most buyers are unwilling to purchase an entire lot of distressed inventory online (e.g., due to the excessive shipping costs), the present system permits individual buyers unknown to one another to team up and get the steep discount of a liquidated item by collectively purchasing the lot. The present system, in effect, creates a completely new distribution channel in the ecommerce space by permitting sellers to sell distressed inventory online directly to consumers. Sellers may also liquidate merchandise at a discount while, at the same time, avoiding the problem in which prospective buyers perceive discounted products as being inherently lower in value. Because the discounts are aggregated and not tied to a specific brand or product, prospective buyers are less likely to perceive the discounts as corresponding to reduced worth. The foregoing benefit is particular important in circumstances in which wineries and other distributors need to quickly sell last year's vintages without having to lower the price of the specific bottles. When a new vintage is released, the winery does not need to raise the price back up from a discounted price that buyers might have become accustomed to seeing.

In another embodiment, a method for storing an inventory of purchased items and aggregating one or more of the purchased items in the inventory for shipment may include maintaining, on a cloud server or other computing device (e.g., a physical and/or dedicated server), an inventory of items purchased by one or more buyers 140. For purposes of this disclosure, a “cloud server” may refer to a virtual or shared hosted server. Persons of ordinary skill in the art will readily appreciate that other understood definitions of “cloud server” may likewise accurately describe such computing devices. The inventory may be associated with a user account. The purchased items may include products for future consumption. One or more of the purchased items may have been purchased at different times (i.e., not concurrently). In some embodiments, one or more of the purchased items may have been purchased from different sellers. In some embodiments (e.g., in the case of a “two-way” marketplace), the purchased items that make up the inventory of purchased items may be respectively owned and stored by various sellers. Such embodiments harness networking and computer technology to maintain a virtual inventory that may be aggregated over time. The virtual inventory may correspond to physical product distributed across the physical storerooms of numerous sellers and/or their distributors. The present solution constitutes a substantial improvement over conventional shipping techniques that are not tied to computer networks and computer technology.

The method may include transmitting a request over the communication network from a computing device (e.g., system controller 150) to ship at least one of the purchased items to a predetermined location. The method may include executing instructions stored in memory of the computing device. By way of executing the instructions with a processor of the computing device, the method may include aggregating the requested items to be shipped, offering a discounted shipping rate for shipping the aggregated items, and finalizing the shipping instructions. The method may further include authenticating a user before aggregating the purchased items. In some embodiments, the method may further include shipping the aggregated items to a desired location.

The method not only benefits buyers, as discussed above, but also benefits sellers by permitting them to offer discounted or free shipping in a way that is cost-effective for each seller. Namely, the method spreads the cost of offering such shipping across a plurality of different sellers who own one or more purchased products in the inventory associated with a given buyer. Each individual seller may offer a low-cost shipment option without having to fund the entire discount. At the same time, buyers may receive discounted or free shipping fees.

In some cases, the cost of shipping a purchased inventory of items may be less than the shipping fees collected from the different sellers. As a result, a profit source or windfall may be generated even while allowing buyers to enjoy discounted or free shipping and allowing sellers to distribute shipping costs effectively. In one example, a buyer may purchase 4 bottles of wine from each of 4 different wineries for a total of 16 bottles. The total shipping cost for the inventory may be $3 per bottle and $3 per order, which may result in a total shipping cost of $60. The wineries may split the shipping cost evenly, which may result in a total shipping cost of $15 for each winery. The buyer may receive free shipping and, if the bottles can be shipped for less than the $60 collected from the wineries, a profit or windfall may be generated.

In yet another embodiment, a non-transitory computer-readable storage medium may include a computer program that, when executed by a processor, performs a method for storing an inventory of purchased items and aggregating one or more of the purchased items in the inventory for shipment as described above.

In a further embodiment, an apparatus for storing an inventory of purchased items and aggregating one or more purchased items in the inventory for shipment may include a processor, a network interface communicatively coupled to a communications network, and memory. The memory may store the inventory of the purchased items, one or more of which may have been purchased at different times. The network interface, by way of the communications network, may transmit a request from a computing device to ship at least one of the purchased items to a predetermined location. By way of executing instructions stored in memory, the processor may aggregate the requested items to be shipped, offer a discounted shipping rate for shipping the aggregated items, and finalize the shipping instructions.

The foregoing embodiments of the ecommerce system described herein may provide a unique method by which a buyer may store the items he or she buys in a remote location (e.g., in a cloud-based storage system or other computing device communicatively coupled to a network). The buyer may then, at a later date, aggregate the purchased items and ship them in bulk on demand. By shipping in bulk, the buyer may benefit from cheaper and more efficient shipping options. One embodiment, for instance, may provide a “cloud cellar” that allows buyers to ship wine bottles at a discounted price.

In one example, a buyer may ship 6 bottles for $5 and may ship 12 bottles for free (or, in some embodiments, any number of bottles above 12 for free). In such a scenario, the buyer may use the present ecommerce system to purchase single bottles and, rather than ship them individually and pay shipping costs, aggregate them in the cloud cellar. Once the buyer reaches 6 bottles, the buyer may take advantage of bulk shipping offers (e.g., the offer to ship a bundle of 6 bottles for only $5, or the offer to ship a bundle of 12 bottles for free). Rather than shipping the entire bundle at once, the buyer may select which bottles to include in the shipment and may ship only those desired items to a desired address. Where a buyer has aggregated 20 bottles in the cloud cellar and is on the way to a friend's party, for instance, the buyer may select a nice collection to ship to the party while enjoying a shipping discount (e.g., any purchases above 12 bottles receive free shipping). In some embodiments, items purchased at different times and/or from different sellers may be aggregated in the cloud cellar.

Embodiments permitting aggregated shipping are highly useful when used in the context of selling products that are purchased for future consumption (e.g., wine, beverages, oils, vinegar, books, collective items, etc.) or otherwise not needed at a specific time in the near future. Such embodiments offer time shifted savings and permit buyers to save money by enjoying bulk discounts and time sensitive discounts without having the physically store the purchased products. Such embodiments are also highly effective for managing stock inventory (e.g., as may be performed by a medical supply company). In the example of a medical supply company, a buyer may buy stock and store electronic representations or records of stock in a networked computing device (e.g., in a cloud-based storage system or other computing device). The medical supply company may then aggregate the purchased goods and ship them to a given clinic as needed.

Moreover, such embodiments provide buyers with the ability to take advance of limited-time and/or limited-quantity offerings without having to be immediately available (or to have physical storage space immediately available) to receive delivery. As a result, buyers may take advantage of offers while supplies last even when they do not have sufficient storage space or are otherwise unable to receive delivery of the merchandise at a given time. In some embodiments of the ecommerce system, the size of the remote storage offered to a given buyer may be variable and be correspond to different price levels. In other embodiments, the size of the remote storage may be unlimited and may not be accompanied by any additional charge.

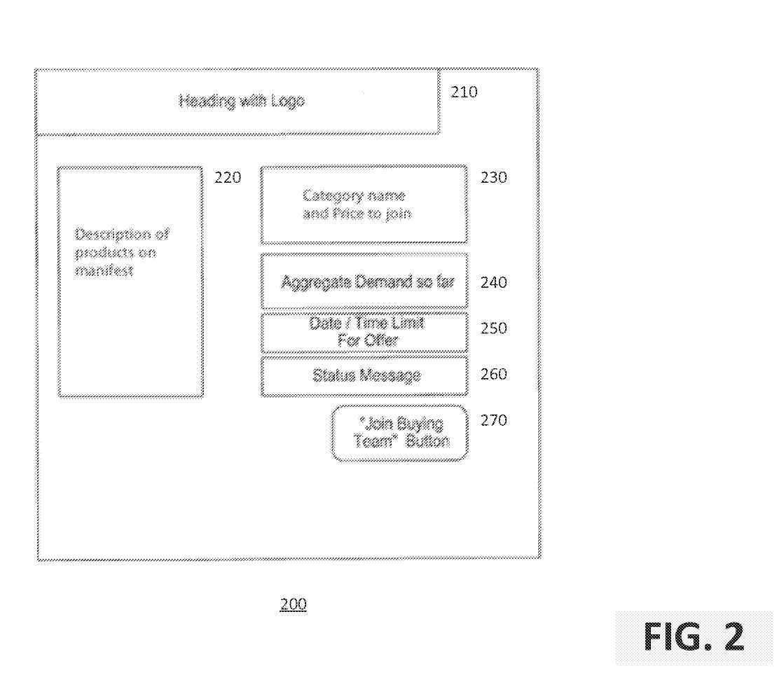

FIG. 2 illustrates an exemplary graphical user interface 200 that may be rendered and displayed at buyer client device 140. Graphical user interface 200 may be rendered and displayed at buyer client device 140 by system controller 150. Graphical user interface 200 may be presented as a webpage and accessed by way of a local Internet browser application (e.g., Chrome™, FireFox™, Safari™, Opera™, Internet Explorer™ and the like) executed at buyer client device 140. Graphical user interface 200 is presented for illustrative purposes only and may, in other possible embodiments, include more or less elements than those shown in FIG. 2. FIG. 2 is not intended to illustrate a webpage layout design, but rather is intended to illustrate certain elements of one possible graphical user interface 200. In operation, graphical user interface 200 may be presented in the context of such a layout to create an aesthetically appealing design.

Graphical user interface 200 may include a plurality of data fields, some of which may be selectable, fillable, or otherwise susceptible to user manipulation. Graphical user interface 200 may include, for instance, a heading field 210. Heading field 210 may include text and/or graphics (e.g., a corporate logo) that identify the person or entity operating or sponsoring the system. Graphical user interface 200 may include an item manifest pane 220. Item manifest pane 220 may identify one or more items as being included within the offers manifest. The one more items included in the offers manifest may be items of which the buyer is guaranteed to receive a portion. Item manifest pane 220 may further describe other terms supplied by the seller, such as information identifying the condition of an offered item, applicable expiration dates, product information (e.g., brand, make, model, year, etc.) and the like.

Graphical user interface 200 may include a category and price field 230. Category and price field 230 may include information the category of products offered and/or the price per portion of the lot for a particular offer. Graphical user interface 200 may further include a demand field 240. Demand field 240 may indicate the current aggregate demand for the offer at issue (e.g., the total number of portions of the offered product that interested buyers have collectively indicated a desire to buy). In other embodiments, demand field 240 may indicate how many individual buyers have indicated a desire to buy any number of portions of the offer. Demand field 240 may further indicate the maximum available amount level for the offer, in addition to a variety of other types of information.

Graphical user interface 200 may also include a time limit field 250. Time limit field 250 may indicate the date and time at which the buying process or cycle will terminate. Graphical user interface 200 may include a status message field 260. Status message field 260 may display one or more status messages concerning the offer. Graphical user interface 200 may include a selectable element 270 (e.g., a button, link, or the like) that, when selected by a user, indicates the user's desire to join the buying process.

Although graphical user interface 200 of FIG. 2 illustrates single offer, it should be understood that graphical user interface 200 may likewise offer multiple offers within the same interface. The various data fields discussed above may be repeated for each offer, or they may be displayed to varying degrees as applicable to each offer. In some embodiments, each field may display information about multiple offers. Graphical user interface 200 may also include other fields unrelated to the offer (e.g., conveying advertising information).

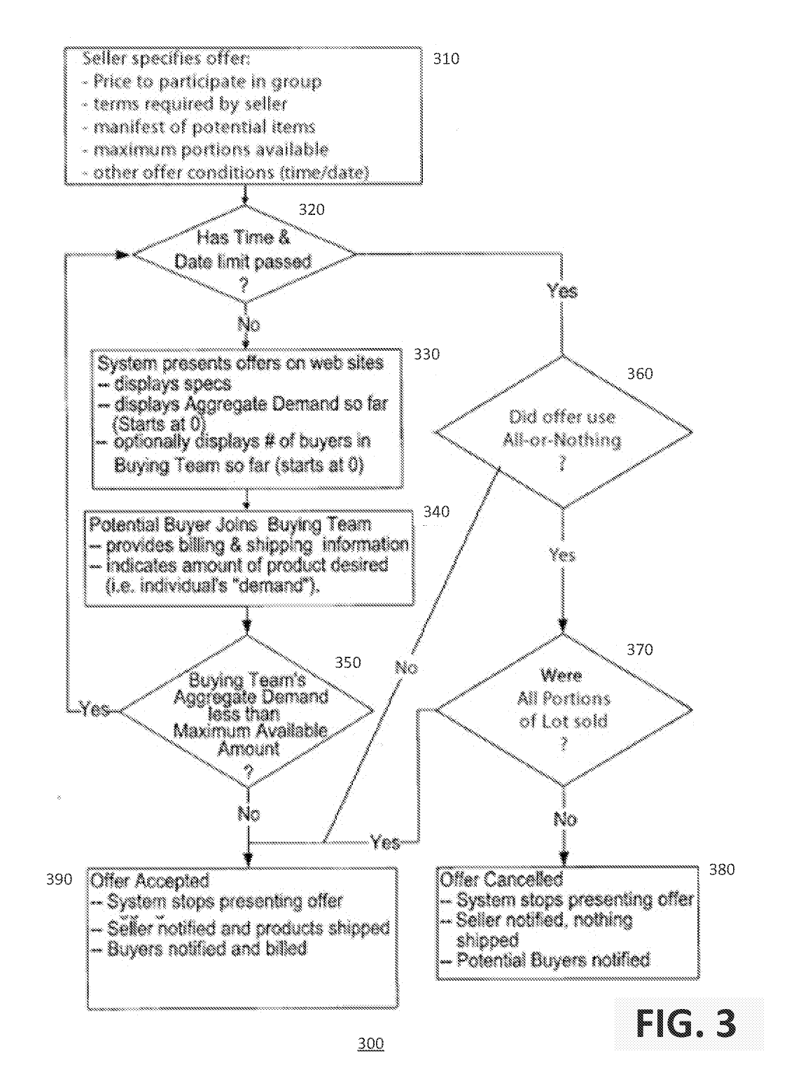

FIG. 3 illustrates an operational flow 300 of an exemplary ecommerce system for marketing mixed lots of distressed inventory. Beginning at block 310, a seller may make an offer to sell a lot of products at a specified flat-price per portion of the lot. The seller may, for example, indicate that he or she will sell each portion of a given lot for $20. The seller may then identify one or more of the items in the lot along with item information and offer details. The seller may also specify that the buying cycle will last for a predetermined period of time (e.g., 48 hours). In one possible example in which a seller may specify that the buying cycle will last 48 hours, the number of purchase requests at the end of 48 hours may determine how many portions were sold. In some cases, no purchase requests may be accepted after the 48-hour period has expired. The seller may also enable an “all or nothing” functionality that imposes a deadline by which all units must be sold or the offer is canceled.

At block 320, the system may determine whether the specified time and date limit for the offers has passed. When the time or date limit of the offers has not passed, the system may display the offer by way of a graphical user interface (e.g., graphical user interface 200 of FIG. 2) at block 330. The graphical user interface may display a plurality of offer-related data, including offer specifications, an identification of the current aggregate demand, and/or the number of buyers participating the offer so far. Having viewed the offer by way of the graphical user interface, a buyer may indicate a desire to participate in the offer or “join the buying team.” In one embodiment, the buyer may do so by selecting selectable element 270 of FIG. 2. At block 340, the buyer may provide, and the system may receive, billing and shipping information. In some embodiments, buying and shipping information may be supplied earlier in the process as part of a registration step. The buyer may also indicate the amount of portions desired (i.e., the level of that particular buyer's “demand” for the offer).

At block 350, the system may compare the buying team's aggregate demand to the maximum available amount previously specified by the seller at block 310. The system may calculate the aggregate demand by summing all of the buyers' individual demand levels for the offer. The system may determine whether the aggregate demand is less than the maximum available amount identified by the seller. In some instances, the seller may not specify a maximum available amount. In such cases, the system may consider the maximum available amount as an unlimited or infinite value. The system may, in those cases, deem the answer to the determination made at block 350 to be “yes.” The system may assume that the aggregate demand less than the maximum available amount when the seller did not specify a maximum available amount.

When the buying team's aggregate demand is less than the maximum available amount, process 300 may loop back to block 320 and determine whether the predetermined time and date limit has yet to pass. As indicated at block 330, when the time and date limit still has yet to pass, the system may continue to present the offer at block 330. At block 350, when the system determines that the buying team's aggregate demand is not less than the maximum available amount (i.e., when all of the portions have been sold), then the system may deem the offer accepted at block 360. At block 360, the system may cease presenting the offer and may notify the buyer and/or seller.

Although FIG. 3 illustrates that, in one embodiment, the system may check the time and date limit at block 230 after a buyer joins a the buying team, the system may also regularly check the time and date limit according to a predetermined interview configurable by the system operator (e.g., the system may check the time and date limit once per minute). Regularly checking the time and date limit may include using one or more independent software processes or threads that run in parallel to the processes or threads performed by the system (e.g., in computing environments such as Unix, Windows NT, and Java).

At block 370, when the system determines that the offer's time and date limit has passed (e.g., when the seller specified that the offer ends at 2:00 PM on Dec. 25, 1999 and that time and date have passed), the system may perform an “all-or-nothing” check. In one embodiment, the system may determine whether the seller selected an “all-or-nothing” requirement. When the seller selected an “all-or-nothing” requirement, the system may, at block 380, determine whether all units for the offer were sold. Determining whether all units for the offer were sold may include determining whether the aggregate demand is equal to the total maximum units for the offer. The aggregate demand may be the total amount of product all of the buyers in the buying team have collectively expressed a desire to buy.

When the seller has selected an “all-or-nothing” requirement and the aggregate demand meets the specified total maximum units, the system may deem the offer accepted at block 360. Upon deeming the offer accepted, the system may automatically notify the buyer and/or the seller. At block 390, when the seller has selected an “all-or-nothing” requirement and the aggregate demand fails to meet the specified total maximum units, the system may cancel the offer due to insufficient aggregate demand. The system may cease presenting the offer and may automatically notify the buyers and sellers that the offer was canceled.

When the system deems the offer accepted at block 360, the system may automatically charge the buyers by way of the buyers' submitted payment information. The product may then be shipped to the buyers. In some embodiments, the system may calculate and disperse commissions. When, for example, the system is being operated by a first entity and the products are being sold by a second, different entity, the system operator may receive a pre-negotiated commission or fee while the actual seller receives the remainder of the selling price. In an alternate scenario, the seller may also be the owner of the goods. In such cases, the seller's revenue may originate from the margin obtained by selling the goods.

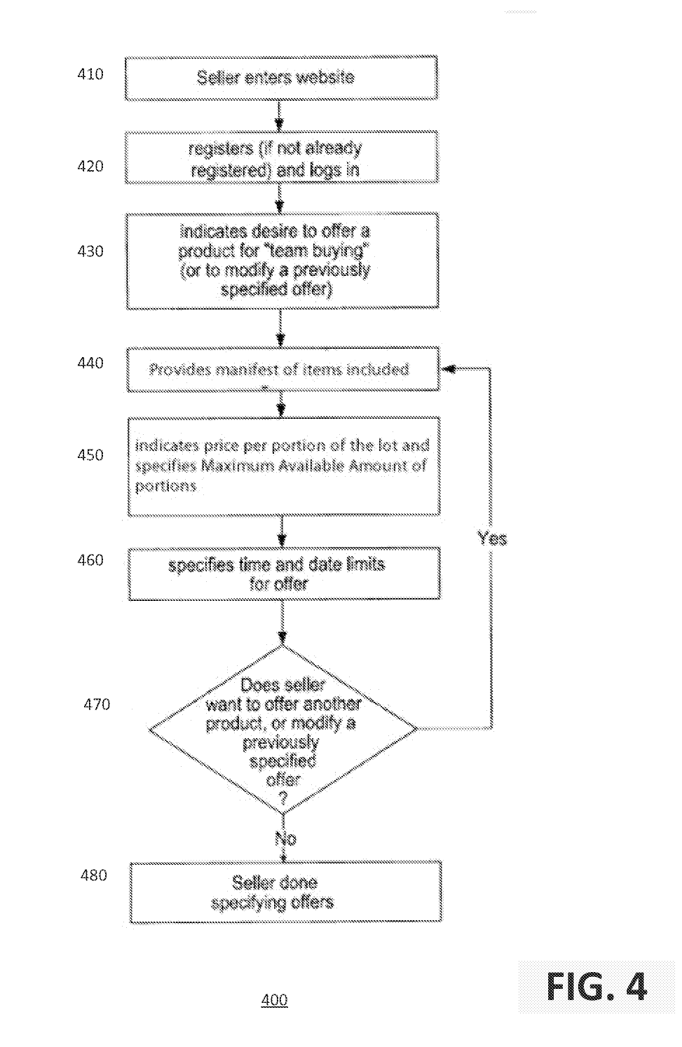

FIGS. 4 through 8 each illustrates an exemplary operational flow of one or more steps summarizes in FIG. 3. FIG. 4 illustrates an exemplary operational process performed by an exemplary ecommerce system when receiving and communicating an offer for sale. Process 400 may be performed upon execution of a software module by a processor of the system. As shown in FIG. 4, process 400 may include the system receiving and communicating an offer for sale. At block 410, the seller may establish a communication link with the system by way of establishing a network connection and submitting data and commands to the system by way of a graphical user interface (e.g., graphical user interface 200 of FIG. 2 as might be displayed in the form of a website). At block 420, the system may receive registration information from the seller when the seller has not previously submitted registration information. In some embodiments, receiving registration information may include receiving seller contact information and credit information (e.g., a social security and/or business ID). The system may verify the seller's authenticity and credit worthiness and determine whether the seller meets certain predetermined criteria. The criteria may be customizable and configurable by the system operator. When the system determines that the seller meets the predetermine criteria, the system may authorize the seller to access to the system. The system operator may provide the seller with an identification name or number and password that allows the seller to log in to the system.

In alternative embodiments, the system may, by way of the system controller (e.g., a plurality of servers, databases, and/or server software) may be configured to automatically check the seller's credit history and automatically generate an identification name or number and password for the seller. Alternatively, the system may allow the seller to create his or her own identification name or number and password. Once registered, the seller may log into the system using the established credentials (e.g., the identification name or number and password).

At block 430, the seller may indicate whether he or she wishes to enter the specification for a team buy offer (i.e., whether the seller wishes to offer one or more portions of a lot to one or more buyers). Alternatively, the seller may indicate whether he or she wishes to modify the specification for a previously entered offer.

At block 440, when the seller selects to enter a new team buy offer or modify a previously entered team buy offer, the seller may submit to the system by way of the graphical user interface a set of information that defines the offer (e.g., a set of offer parameters defining an offer manifest). The seller may submit or modify a description of the offer stored in memory of the system. The seller may, for instance, provide text that reads “Electronics Deal.” The seller may also specify all known information about the lot, including product names, descriptions, the condition of the product, and other information that may be useful to the buyer in making a purchase decision.

At block 450, the seller may also specify a maximum available amount of portions of the lot that are available for sale during the offer. The maximum number of portions available may be equal to the total number of separate items in the lot. When the seller has a lot of goods with 300 different items, for instance, then there may be a maximum of 300 separate portions of the lot that can be sold. The system may receive the information submitted by the seller. The seller may further submit, and the system may further receive, a specified price per portion at which the seller wishes to offer the lot of products.

At block 460, the system may receive a date and time limit for the offer from the seller. The seller may, for instance, indicate that the offer is subject to an “all-or-nothing” requirement (e.g., if the maximum available units is 300 units, then the offer may not be deemed accepted unless the system received an indication that one or more buyers wish to purchase all 300 units by a predetermined time and date). When the all-or-nothing requirement is not met by the offer deadline, the system may deem the offer canceled. In some embodiments, the system may not require the seller to submit a time and date limit (i.e., an offer deadline). Providing a time and date limit may, however, incentivize buyers to act sooner, and provide an automatic mechanism by which a seller may cancel the offer when the offer fails to generate a satisfactory level of demand.

The system may, at block 470, determine whether the seller wishes to offer another product (e.g., whether the seller wishes to configure an additional team buy offer) or modify a previously configured offer. Determining whether the seller wishes to offer another product or modify a previously configured offer may include receiving an indication from the seller by way of a graphical user interface displayed at the seller client device. When the seller enters an offer, the system may presents the offer to one or more prospective buyers by way of a graphical user interface displayed at the buyer client device until the time and date limit specified by the seller passes or the aggregate demand rises to match the specified maximum available amount. When the system determines that the seller wishes to offer another product (or lot of products) or modify a previously configured offer, process 400 may loop back to block 440. When the system determines that the seller does not wish to offer another product (or lot of products) or modify a previously configured offer, the system may conclude that the seller is done specifying offers.

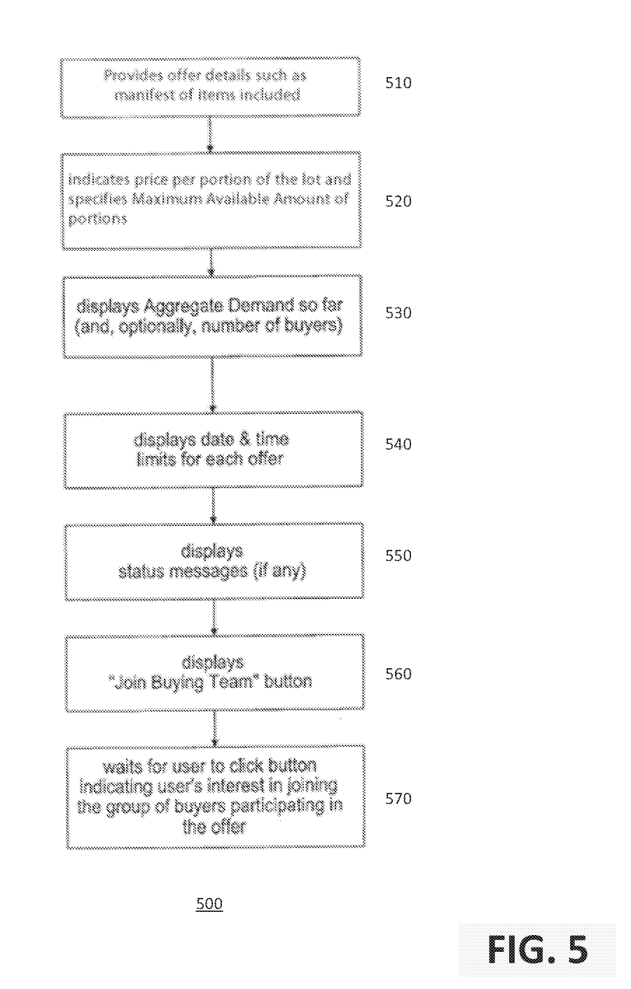

FIG. 5 illustrates an exemplary operational process 500 performed by an exemplary ecommerce system when presenting an offer for sale to one or more prospective buyers. Process 500 may be performed upon execution of a software module by a processor of the system. As shown in FIG. 5, process 500 may include presenting an offer for sale to one or more prospective buyers by way of a graphical user interface (or series of such interfaces) displayed at a buyer client device associated with each prospective buyer. For each offer presented, the system may display a plurality of information submitted by the seller or determine by the system controller. At block 510, for instance, the system may display the offer details and terms (e.g., a manifest of goods, item conditions, or other information about the lot). At block 520, the system may display the established price per portion and the maximum available amount (if one was specified by the seller). At block 530, the system may display the current aggregate demand (i.e., the total amount of purchasing interest that prospective buyers have collectively expressed since the start of the offer). The system may further display the number of buyers currently in the buying team. The system may also display, at block 540, the time and date limit for the offer (e.g., the offer deadline) specified by the seller.

At block 550, the system may display a status message concerning the offer (e.g., “Time's running out . . . this deal's about to expire!”). The system may display a selectable element that, when selected by a prospective buyer (e.g., when clicked upon), indicates an interest in joining a buying team. In some embodiments, potential buyers may pre-purchase packages of future offers. In such cases, a prospective buyer may not need to specify his or her intent to purchase each specific offer by clicking the selectable element. The selected element may be labeled with text or graphics (e.g., with a label such as “Join Buy Team,” “Get in The Group”, “Get In On It”, “Buy Now,” “Buy,” or any other desired label.). At block 570, the system may wait to receive a user indication delivered to the system by way of selecting the selectable element.

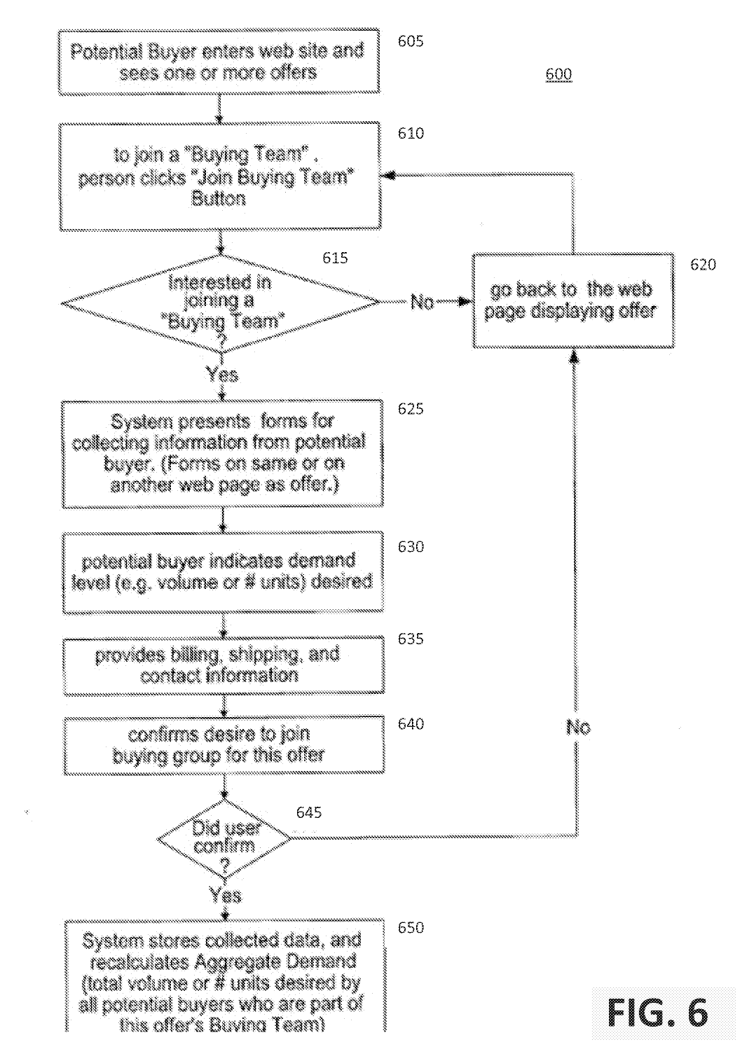

FIG. 6 illustrates an exemplary operational process 600 performed by an exemplary ecommerce system when a potential buyer joins a buying team. Process 600 may be performed upon execution of a software module by a processor of the system. As shown in FIG. 6, process 600 may include operations that occur when a potential buyer joins a buying team. At block 605, a potential buyer may access the system by way of a graphical user interface rendered and displayed at a buyer client device associated with the potential buyer. Upon accessing the system, the buyer may view one or more offers presented by the system. At block 610, the system may receive an indication of the buyer's desire to join a buying team. At block 615, the system may interpret the indication as an indication that the buyer wishes to join a buying team. When the system determines that the buyer does not wish to join a buying team (e.g., when the user fails to click the selectable element before a predetermine time period or selects a further selectable element indicating a lack of desire to join a buying team), then at block 620 process 600 may loop back to block 610. Receiving the indication may include receiving an indication by way of the potential buyer clicking on a selectable element displayed at the graphical user interface (e.g., a “join buy team” button). In this embodiment, the system proceeds to walk the potential buyer through the process of signing up to join the Buying Group for this offer.

At block 625, the system may present one or more fillable or otherwise user-configurable forms by which the system may collect information from the potential buyer. In some embodiments, the one or more forms may be presented on the same graphical user interface (e.g., web page) where the offer was presented, while in other embodiments the one or more forms may be presented on a separate and distinct graphical user interface linked to the interface displaying the offer.

At block 630, the system may receive from the buyer one or more purchase parameters. The purchase parameters may include a desired level of demand (e.g., the volume or quantity of portion of a specific offer desired if the offer is ultimately accepted by the system). The desired level of demand may represent the potential buyer's individual demand as distinguished from the aggregate demand associated with the entire pool of buyers in a buying team. If the offer is an electronics lot, for instance, the potential buyer might indicate an interest in buying five portions of the electronics lot. The system may prohibit a buyer from requesting to purchase (i.e., expressing a demand for) more portions than are available. The portions available may be indicated by the maximum available amount specified by the seller. When determining whether a buyer is attempting to exceed the maximum available amount, the system may consider the aggregate demand already expressed by other buying team members plus the number of portions requested by the new potential buyer. When the new potential buyer requests too many portions, the system may notify the new potential buyer. The system may, for instance, display a message by way of a graphical user interface displayed at a buyer client device associated with the new potential buyer. The message may indicate how many portions actually remain and may invite the new potential buyer to re-enter a lower desired number of portions.

At block 635, the potential buyer may provide, and the system may receive, the buyer's payment information (e.g., card number, expiration date, billing address, security code, and the like). The system may further receive the buyer's shipping address and contact information (e.g., email address). At block 640, the system may receive confirmation from the potential buyer that the potential buyer desires to join a buying team for the presented offer. At block 645, the system may determine whether the potential buyer confirmed a desire to join a buying team. When the potential buyer confirms an interest in joining a buying team for the offer at block 650, the system may store the collected data. The system may store the data in memory, either locally or in a remote storage location (e.g., in a central database server). Based on the desired demand level received from the buyer at block 630, the system may recalculate and update the aggregate demand for the offer at block 650.

As discussed above, the aggregate demand may be the sum of every individual buyer demand level in the buying team. If, for example, a buying team has three members in the context of the electronics lot example discussed above, a first buyer may have indicated a demand level of 5 portions, while a second buyer may have indicated a demand level of 1 portion, and a third buyer may have indicated an interest in buying 20 portions. In that scenario, the aggregate demand for the lot would be calculated by adding the individual demand levels, which would equal 26 total portions. The aggregate demand may be expressed in terms of portions of the lot. In some embodiments, the system may offer a lot that includes more items than portions being offered. In those cases, multiple items of merchandise may be shipped per portion of the offer desired.

As described earlier and as indicated by blocks 320, 350, and 360 of FIG. 3, the system may monitor aggregate demand and a specified time and date limit (i.e., an offer deadline or expiration date) during a buying cycle associated with each offer. The buying cycle may begin when the offer is first created by the system and may end when the time and date limit has passed. When the aggregate demand reflecting the buying team's collective demand rises to match the maximum available amount for an offer (as discussed in the context of block 350 of FIG. 3) or if the time or date limit has passed (as discussed in the context of block 320 of FIG. 3) and the aggregate demand has risen to match the maximum available amount by that time, then the system may deem the offer accepted. When the time and date limit is exceeded and the aggregate demand remains below the lowest demand threshold for accepting the offer, the system may cancel the offer. In some embodiments, the system may cancel the offer after confirming that the seller did enabled an all-or-nothing requirement and that less than all of the portions of the offered lot were claimed by buyers.

In one exemplary scenario, a seller may offer a lot of 1,400 sporting good items. Each portion of the lot may cost $10. The seller may specify that the maximum available amount is 700 portions. In such a case, if the aggregate demand (i.e., the total number of portions collectively desired by all members of the offer's enrolled buying team) reaches 700 portions before the time and date limit specified by the seller has passed, the system may deem the offer accepted. At that point, each enrolled buying team member may receive 2 items from the lot. On the other hand, if the time and date limit passes and the aggregate demand has only reached 112 portions, the system may determine whether the seller enabled an all-or-nothing requirement. If the seller enabled an all-or-nothing requirement, then the system may cancel the offer because less than all of the portions were claimed (i.e., only 112 out of 700 available portions). The system may notify any potential buyers who expressed interest in joining the buying team for the offer that the offer has been cancelled due to insufficient demand.

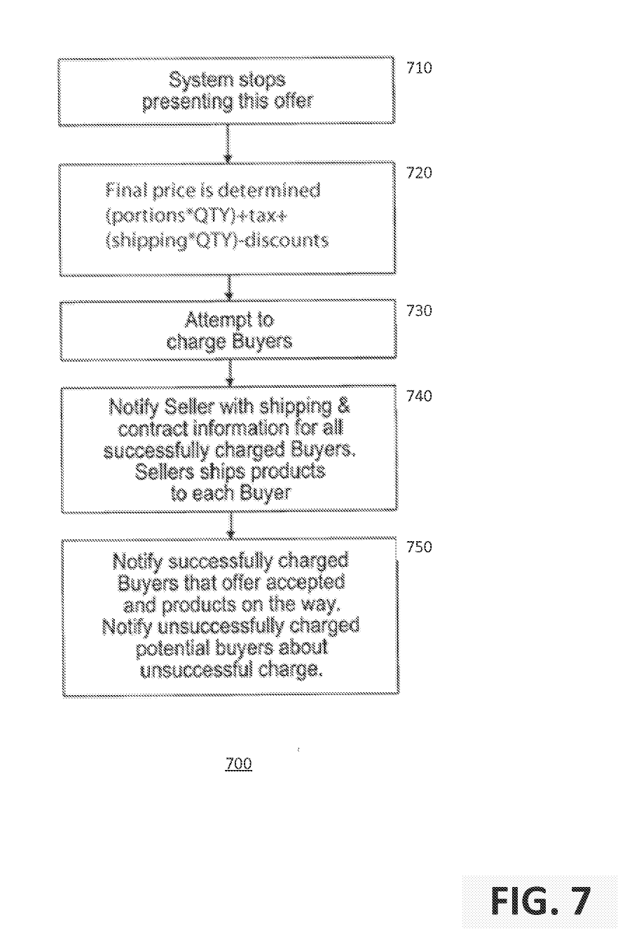

FIG. 7 illustrates an exemplary operational process 700 performed by an exemplary ecommerce system when accepting an offer. Process 700 may be performed upon execution of a software module by a processor of the system. As shown in FIG. 7, process 700 may include accepting an offer under circumstances in which a buying team has indicated sufficient demand for an offer. At block 710, the system may stop presenting the offer. Ceasing to present the offer may include deleting an offer from a graphical user interface or otherwise indicating that the offer is no longer available (e.g., by changing the font color, by using strikethrough, or any number of other suitable manners). The system may display a message indicating that the offer has been completed successfully.

At block 720, with the offer having been accepted, the system may determine a final price or cost associated with the offer for each buyer. In one embodiment, determining the final price for each buyer may include adding the quantity of the number of portions multiplied by the portion price to the quantity of the number of portions sold by the shipping price per portion. Determining the final price may include accounting for any applicable taxes, handling charges, and discounts that the system needs to apply. Persons of ordinary skill in the art will readily recognize that the final price may be determined in many other ways and that the exemplary calculation presented herein is in no way limiting.

At block 730, the system may automatically charge each member of the buying team using the credit card information or other payment information previously supplied by each buyer and stored by the system. In some instances, the system may prompt the buyer to provide new payment information. The system may charge each member of the buying team the final price. The system may track which buyers were successfully charged to account for the possibility that, in some instances, payment methods fail (e.g., a credit card charge may not go through successfully if a potential buyer's credit card has expired or is over its credit limit). In some embodiments, the system may automatically create invoices for buyers who prefer to be billed rather than paying by credit card. The system may store buyer payment information for automatic billing purposes. The system may also receive and maintain a deposit account for each buyer. Alternatively, the system may accept payment by way of a third-party payment service such as PayPal, Amazon Payments, Google Checkout, and the like. Buyers may, in some embodiments, subscribe to packages of offers such that they prepay for goods that are delivered periodically in the future (e.g. on a weekly, monthly, or custom delivery schedule).

The system may, at block 740, notify the seller that the offer was accepted and has been processed successfully. The system may provide the shipping and contact information for each successfully charged buyer. The seller may then ship the number of units that correspond to the quantity of portions purchased by each buyer. In some cases, the seller may ship all of the units in bulk to a fulfillment company or to the system operator. The fulfillment company or system operator may then handle shipping subsets of the units to individual buyers as instructed by the system (e.g., in a scenario in which the system operator is also the owner of the goods being sold).

Although the system has been described in the context of selling goods for illustrative purposes, persons of ordinary skill in the art will readily appreciate that the system applies equally to the sale of services. In an embodiment in which an offered lot includes services rather than products, the seller may perform the purchased service for each buyer rather than shipping a product. Alternatively, the seller may provide a service voucher for each buyer. Each buyer may then redeem the service at his or her convenience.

At block 750, the system may automatically notify members of the buying team that the offer was accepted. The system may notify each buyer that his or her payment information has been used to pay for the purchased good or service. The system may notify each buyer when the good or service voucher has been shipped. The system may likewise notify potential buyers who were not successfully charged that no product was shipped in light of the payment failure.

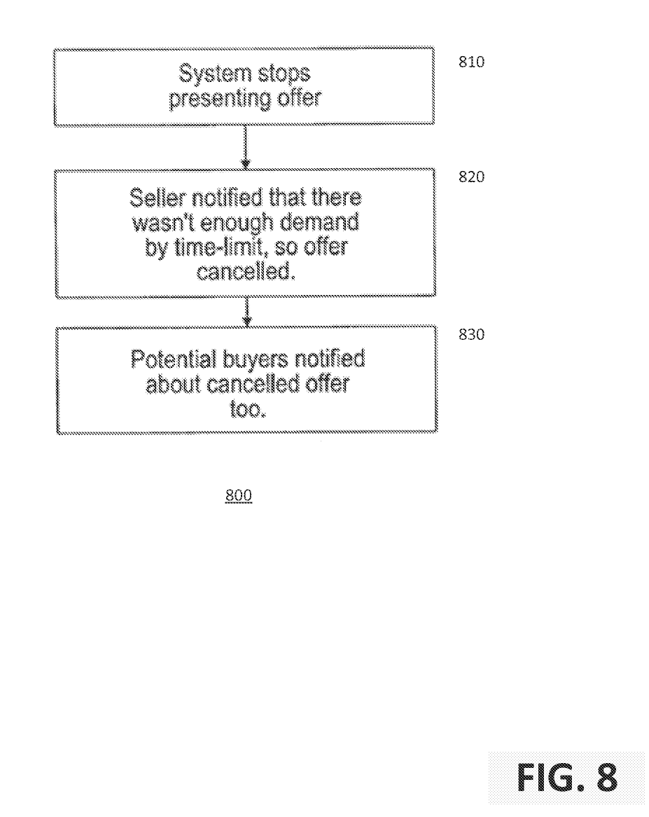

FIG. 8 illustrates an exemplary operational process 800 performed by the system when canceling an offer. Process 800 may be performed upon execution of a software module by a processor of the system. As shown in FIG. 8, process 800 may include notifying buyers and sellers that the system has canceled an offer due to insufficient demand. At block 810, the system may cease presenting an offer for which insufficient demand has been expressed. The system may, at block 820, notify the seller that the system received insufficient indications of buyer demand before the time and date limit specified by the seller passed. The system may inform the seller that the offer was canceled. At block 830, the system may notify potential buyers that the offer was canceled due to insufficient demand.

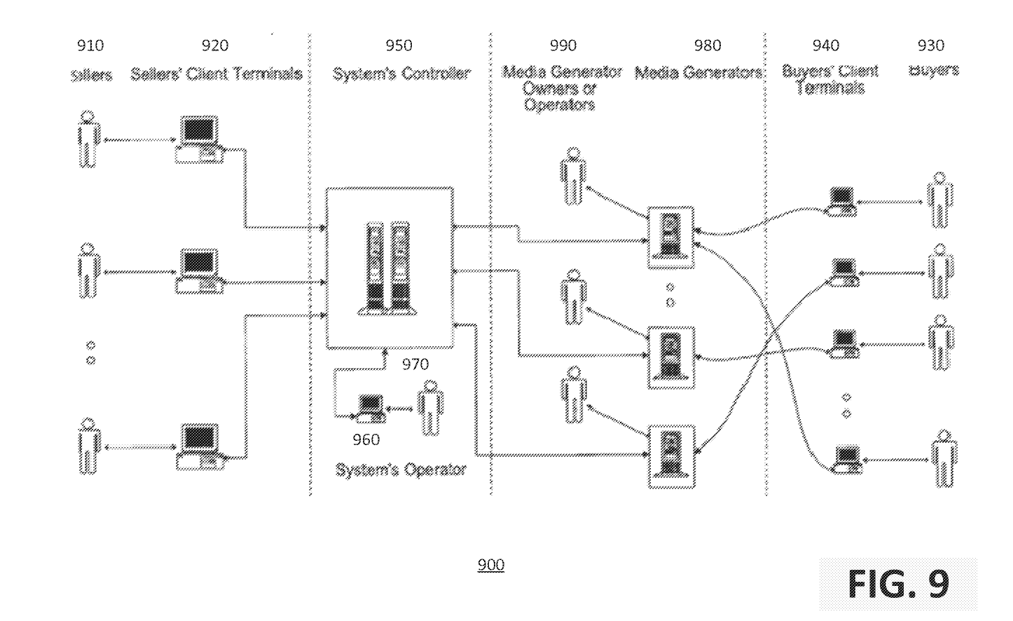

FIG. 9 illustrates an exemplary network environment 900 in which another embodiment of an ecommerce system may be implemented. Embodiments of the solution described herein (e.g., systems, methods, apparatuses, and non-transitory computer-readable storage media) may be employed over a network such as the Internet. Such embodiments may likewise be employed using other communications systems, including voice telephony and communication systems that incorporate web cameras, mobile phones, and web-enabled televisions. Environment 900 may include a plurality of sellers 910 each associated with a seller client device 920. Environment 900 may further include a plurality of buyers 930 each associated with a buyer client device 940. Seller client devices 920 and buyer client devices 940 may be communicatively coupled to one another by way of a communications network as discussed in the context of FIG. 1.

A system controller 950 may be communicatively coupled to the network between seller client devices 920 and buyer client devices 940. A system operator client device 960 may be coupled to system controller 950. System operator client 960 may be associated with a system operator 970 who operates the ecommerce system within environment 900. In some embodiments, a plurality of media generators 980 may be communicatively coupled to the communications network. The media generators may each be associated with a media generator owner or operator 990.

As used in the present disclosure, the term “system operator” does not necessarily refer to an individual. The term “system operator” may encompass any person (e.g., an entrepreneur), entity, enterprise that operates system controller 970, irrespective of whether or not system operator 970 owns and operates system controller 970 or if there is a separate business relationship between the person responsible for the system and the party or entity that owns or operates the actual computer systems and web servers that provide the functions of system controller 970. In the embodiment shown in FIG. 1, the system operator's server (which may be included within system controller 150) hosts the web-based graphical user interface that is viewed by potential buyers. In the embodiment shown in FIG. 9, the web-based graphical user interfaces that may be viewed by potential buyers are hosted on servers owned and operated by individuals or entities (i.e., media generator owners or operators 990) that differ from the entity that owns or operates system controller 970. In some instances, the system may offer lots of product on behalf of system operator 970. In other cases, the system may offer lots of product on behalf of third parties unrelated to system operator 970. When the system offers lots of product on behalf of third parties, the system may automatically calculate and grant system operator 970 a commission or fee when an offer is accepted and shipped. The system may then transmit the remaining revenue to the third-party sellers.

The foregoing detailed description has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to enable others skilled in the art to best utilize it in various embodiments and with various modifications as suited to the particular design considerations at issue (e.g., cost, availability, preference, etc.). The scope of the technology should be defined only by the claims appended to this description.

What is claimed is:

1. A method for facilitating a buyer to participate in purchasing a portion of an aggregated mixed lot of goods from a seller, the method comprising:
receiving, by way of a communication network, offer information from a seller at a server, the offer information including:
an itemized manifest of items within the aggregated mixed lot of goods,
an indication that the aggregated mixed lot of goods includes one or more upgraded items, and
a price for an item; and
executing instructions stored in memory, wherein execution of the instructions by a processor:
stores the offer information received from the seller in a non-transitory computer readable storage medium,
receives an order corresponding to the offer information,
delivers a request from the buyer to the seller to purchase the portion of the aggregated mixed lot of goods,
delivers a payment from the buyer corresponding to the purchase, and
receives a detailed item list of all goods the buyer purchased.

2. The method of claim 1, wherein the offer information further includes delivery information.

3. The method of claim 1, wherein the offer information further includes information about the upgraded items.

4. The method of claim 3, wherein the information about the upgraded items includes at least one of: a name, an image, an identification of a manufacturer, an MSRP, and a percentage of the upgraded items included in the mixed lot.

5. The method of claim 1, wherein the offer information does not include any information about the upgraded items.

6. The method of claim 1, wherein the detailed item list of all goods includes an identification of any upgraded items included in the purchase.

7. The method of claim 1, wherein the detailed item list of all goods omits any identification of any upgraded items included in the purchase.

8. A method for storing an inventory of purchased items and aggregating one or more of the purchased items in the inventory for shipment, the method comprising:
maintaining, at a server, an inventory of the purchased items, wherein one or more of the purchased items were purchased at different times;
transmitting a request over a communication network from a computing device to ship at least one of the purchased items to a predetermined location; and
executing instructions stored in memory, wherein execution of the instructions by a processor:
aggregates the requested items to be shipped,
offers a discounted shipping rate for shipping the aggregated items, and
finalizes the shipping instructions.

9. The method of claim 8, further comprising shipping the aggregated items to a desired location.

10. The method of claim 8, wherein one or more of the purchased items were purchased from different sellers.

11. The method of claim 8, wherein the inventory is associated with a user account.

12. The method of claim 8, wherein the processor further provides authentication of a user before aggregating the purchased items.

13. The method of claim 8, wherein the purchased items include products for future consumption.

14. An apparatus for storing an inventory of purchased items and aggregating one or more purchased items in the inventory for shipment, the apparatus comprising:
memory that stores the inventory of the purchased items, wherein one or more of the purchased items were purchased at different times;
a network interface communicatively coupled to a communication network, wherein the network interface transmits a request from a computing device to ship at least one of the purchased items to a predetermined location; and
a processor that executes instructions stored in memory, wherein the processor:
aggregates the requested items to be shipped,
offers a discounted shipping rate for shipping the aggregated items, and
finalizes the shipping instructions.

15. The apparatus of claim 14, wherein the aggregated items are shipped to a desired location.

16. The apparatus of claim 14, wherein one or more of the purchased items were purchased from different sellers.

17. The apparatus of claim 14, wherein the inventory is associated with a user account.

18. The apparatus of claim 14, wherein the processor further provides authentication of a user before aggregating the purchased items.

19. The apparatus of claim 14, wherein the purchased items include products for future consumption.

20. A non-transitory computer-readable storage medium, having embodied thereon a program executable by a processor to perform a method for storing an inventory of purchased items and aggregating one or more of the purchased items in the inventory for shipment, the method comprising:
maintaining, on a cloud server, an inventory of the purchased items, wherein one or more of the purchased items were purchased at different times;
transmitting a request over a communication network from a computing device to ship at least one of the purchased items to a predetermined location;
aggregating the requested items to be shipped;
offering a discounted shipping rate for shipping the aggregated items; and
finalizing the shipping instructions.
